(19) United States
(12) Patent Application Publication
(10) Pub. No.: US 2009/0276428 A1
(43) Pub. Date: Nov. 5, 2009

(54) SORTING METHOD AND ALGORITHM CALLED HIGH SPEED SORT

(75) Inventors: BYUNG BOK AHN, Kyungkido (KR); INSIK CHIN, Seoul (KR); KYUNGCHEOL KIM, Seoul (KR); HUNGTAE KIM, Kyungkido (KR); JUNGWON RHYU, Palo Alto, CA (US)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Byung Bok AHN, Kyungkido (KR)

(21) Appl. No.: 12/113,070

(22) Filed: Apr. 30, 2008

(51) Int. Cl. G06F 7/08; G06F 17/30

(52) U.S. Cl. 707/7; 707/E17.104

(57) ABSTRACT

In the field of computer-based data processing, data sorting is an important issue. Among various sorting methods, Quick Sort is generally used. However, there is a problem that using Quick Sort makes sort time longer if the data to be sorted is already partially or fully in order. The invention solves the above-mentioned problem and makes the complexity of the sorting lower than or at least equal to that of Quick Sort. Thus, it provides a faster sorting method than Quick Sort does.

In a method or program of the invention, ‘long sequence’ being defined as a longest monotonously increasing or monotonously decreasing sequence found in N sequence, a ‘smaller values’ being defined as a sequence of data values smaller than a minimum value among the ‘long sequence’, a ‘larger values’ being defined as a sequence of data values larger than a maximum value among the ‘long sequence’, and a ‘between values’ being defined as values which are larger than the minimum value among the ‘long sequence’ and smaller than the maximum value among the ‘long sequence’ other than the ‘long sequence’.

The ‘long sequence’ is already sorted, other three sequences(smaller values, larger values, and between values) is to be internally sorted. Then, the four sequences are merged. Above-mentioned internal sorting uses the method of the invention recursively.

### BACKGROUND OF THE INVENTION

1. Technical Field

The present invention generally relates to an improved sorting method and algorithm called “High Speed Sort,” and in particular to a method and algorithm to reduce complexity of the algorithm compared to Quick Sort.

2. Related Art

In recent years, sorting algorithms have been the most interesting issues in the computer science and engineering fields, related to database, multimedia, the Internet, and so on. It is important that many fragments of the sequential information play roles as the fundamental keys in the above mentioned areas. Especially, the method named Quick Sort is the meaningful algorithm, because it has been known as the fastest sorting algorithm that guarantees O(n log n) in the case of ordering the well shuffled data. However, it has also been known that its inevitable drawback shows O(n²) in the case of sorting the already ordered list, ironically. If partially or fully sorted data are to be processed by Quick Sort, its shortness can affect the application performance. Therefore, many researchers have tried to improve it, focused on how to find the pivot in the partitioning that is the key for Quick Sort.

To improve robustness and speed of Quick Sort pre-described, this invention proposes a novel sorting method or algorithm. It is called “High Speed Sort.” The basic idea of the invention is to find a key sequence of the target list, merge three stage lists, and optimize the partitioning. In this specification, this advantage can be proved mathematically. From these procedures, it can show better performance than that of Quick Sort at the appropriate conditions, sorting partially or fully ordered data. Moreover, if it is used, generally randomized shuffled data can be ordered at the same asymptotic speed as Quick Sort. This is the only poor case of this High Speed Sort algorithm. Qualitative analyses for it are included in this proposal for the improvement of the sorting algorithms.

There are many kinds of sorting algorithms already known to skilled persons in the pertinent art. For example, (1) Bubble Sort, (2) Insertion Sort, (3) Selection Sort, (4) Merge Sort, (5) Heap Sort, (6) Quick Sort etc. might be listed.

With regard to “Related Art”, sorting methods of (1) through (5) will be explained briefly and sorting method of (6) Quick Sort will be presented relatively in detail. It is because, conventionally, Quick Sort is considered as a considerably fastest among pre-mentioned sorting methods and used most frequently.

(1) Bubble Sort

Bubble sort procedure is continuously to exchange the next element with the current key element. Bubble means that the maximal number or minimal number inflates from the first index of the array to the final index.

(2) Insertion Sort

Insertion sort procedure is to find the right position for the current key element. After finding the position, it is rearranging the rest of the elements in the target array.

(3) Selection Sort

Selection sort procedure is to find the smallest value of the rest of the array which have not yet been sorted. The found value is the header of the array.

(4) Merge Sort

Merge sort is to sort the target array by sequential scanning and merging divided a half of the array.

(5) Heap Sort

Heap is nearly complete binary-tree in the computer algorithm, not free-memory which is used by a computer application program. A max heap which has a root of maximum number of the data array can sort the target data in the descending order. Heap sort is to sort the target array, restructuring the max heap.

(6) Quick Sort

Quick Sort is to sort the target array with partition (see C. A. R. Hoare, “Algorithm 63 (Partition) and Algorithm 65 (FIND)”, Communications of the ACM, 4(7), 1961, also see Robert Sedgewick, “Implementing Quick Sort programs”, “Communications of the ACM, 21(10), 1978). This algorithm has a good average-case running time, and no particular input elicits its worst case behavior. To patch this drawback, many researchers have come up with their own algorithms. The first improvement is the randomized Quick Sort which means the selection of the pivot is random. The second thing is the median of three methodologies which is to use the median as the pivot from its partition elements randomly selected.

FIG. 1 shows an algorithm for Quick Sort (prior art).

Referring to FIG. 1, here is the three step divide and conquer process for sorting a typical subarray A[p . . . r].

In FIG. 1, ‘A’ is an array to be sorted, ‘p’ is leftmost value of the array to be sorted, ‘r’ is rightmost value of the array to be sorted.

1) Divide : Partition (rearrange) the array A[p . . . r] into two (possibly empty) sub array A[p . . . q−1] and A [q+1 . . . r] such that each element of A[p . . . q−1] is less than or equal to each element of A[q+1 . . . r]. Compute the index q as part of this partitioning procedure (S101, S101′).

2) Conquer : Sort the two subarrays A[p . . . q−1] and A[q+1 . . . r] by recursive calls to Quick Sort (S102).

3) Combine: Since the subarrays are sorted in place, no work is needed to combine them: the entire array A[p . . . r] is now sorted.

To sort an entire array A, the initial call is Quick Sort (A,1,length[A])

The key to the algorithm is the PARTITION procedure, which rearranges the subarray A[p . . . r] in place (S101′).

In general, PARTITION function selects an element x=A[r] as a pivot element of the partition in the sub array A[p . . . r]. As the procedure runs, the array is partitioned into two subarrays (S101′).

The final two lines of PARTITION move the pivot element into its place in the middle of the array by swapping it with the leftmost element that is greater than x (S103).

The output of PARTITION now satisfies the specification given for the divide step. The running time of PARTITION on the subarray A[p . . . r] is Θ(n), where n=r−p+1.

It is important that Quick Sort has a problem with an already ordered array (i.e., partially or fully ordered data). Because the partition function returns the only one element, Quick Sort makes a biased tree about the ordered array which has the depth of n in the program.

(6-A) A Randomized Version of Quick Sort

FIG. 2 shows unbalanced tree of the week point of Quick Sort (prior art).

In spite of Quick Sort's remarkable performance, it has a weak point with an unbalanced tree in fully ordered array or partially ordered array. Partially ordered array forces it to make a unbalanced binary recursions as FIG. 2.

FIG. 3 shows an algorithm for a randomized version of Quick Sort (prior art).

Referring to FIG. 3, McIlroy devised the different randomized algorithm to get over this weak point of Quick Sort. It is called random sampling (see M.D. McIlroy, “A killer adversary for Quick Sort”, Software-Practice and Experience, 29(4), 1999). Instead of using A[r] of the rightmost element as the pivot, it can use a randomly chosen element from the subarray A[p . . . r]. Exchanging randomly chosen element with an element front the subarray A[p . . . r], it can be expect the split of the input array to be reasonably well balanced.

(6-B) A Median of Three Version of Quick Sort

FIG. 4 shows an algorithm for a Median of three version of Quick Sort (prior art).

Referring to FIG. 4, Median is the middle value among the subarray. Blum, et al. suggested that finding the median of the partition in Quick Sort (see M. D. McIlroy, “A killer adversary for Quick Sort”, Software-Practice and Experience, 29(4), 1999). P. Kirschenhofer, et. al, examined the median of three partitioned Quick Sort algorithm which find the smallest value of the randomly selected three elements in the partition function.

### SUMMARY OF THE INVENTION

### BRIEF DESCRIPTION OF THE DRAWINGS

FIG. 1 shows an algorithm for Quick Sort (prior art).

FIG. 2 shows unbalanced tree of the week point of Quick Sort (prior art).

FIG. 3 shows an algorithm for a randomized version of Quick Sort (prior art).

FIG. 4 shows an algorithm for a Median of three version of Quick Sort (prior art).

FIG. 5A shows a flow chart in accordance with an embodiment of the present invention.

FIGS. 5B and 5C shows a source code list of flow chart of FIG. 5A in accordance with an embodiment of the present invention.

FIG. 6A shows an algorithm of finding a long sequence in accordance with an embodiment of the present invention.

FIG. 6B shows a source code list of flow chart of FIG. 6A in accordance with an embodiment of the present invention.

FIG. 6C shows an explanation on ‘inversion function’ which was stated above.

FIG. 7A shows an algorithm of improved partition and inversion in accordance with an embodiment of the present invention.

FIG. 7B shows a source code list of flow chart of FIG. 7A in accordance with an embodiment of the present invention.

FIG. 8A through 8E shows the whole program code in accordance with an embodiment of the present invention.

FIG. 9 shows the construction of a recursion tree for the recurrence.

FIG. 10 shows comparison to Quick Sort algorithms by running time (sec) in Microsoft.NET Framework 1.1.

FIG. 11 shows running time graph by the input size.

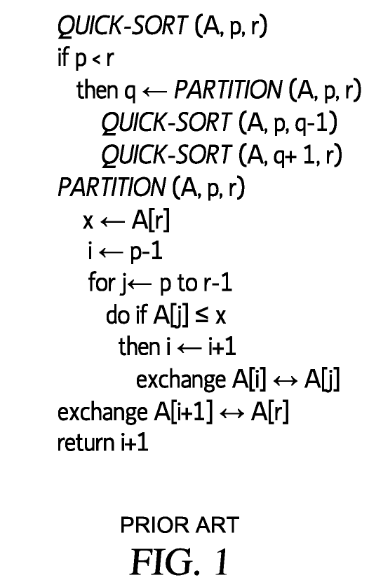

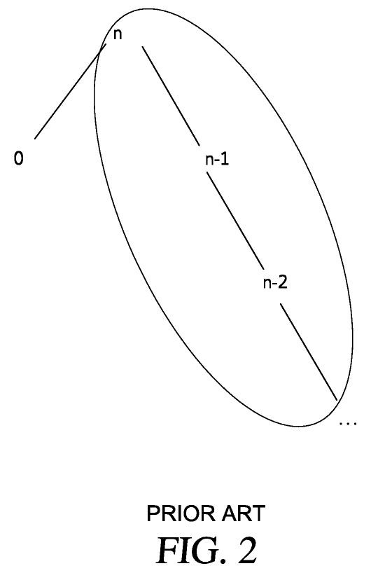

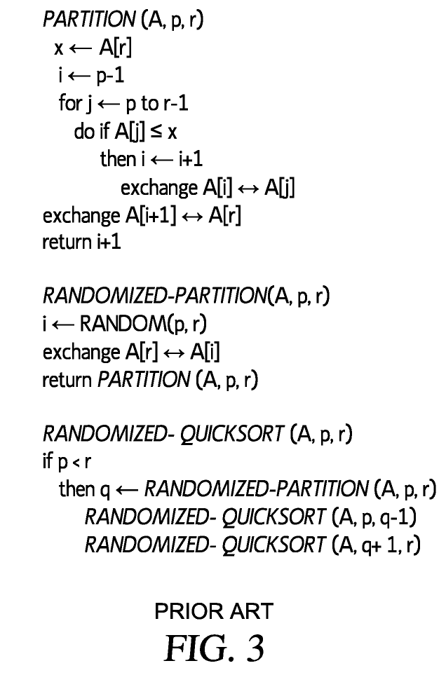

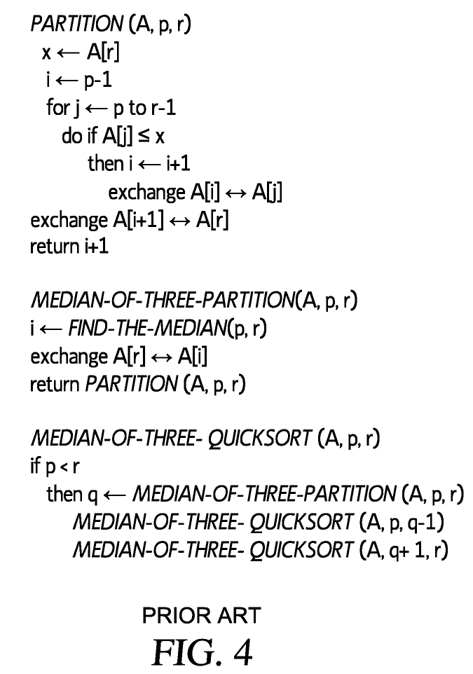

### DETAILED DESCRIPTION OF THE INVENTION

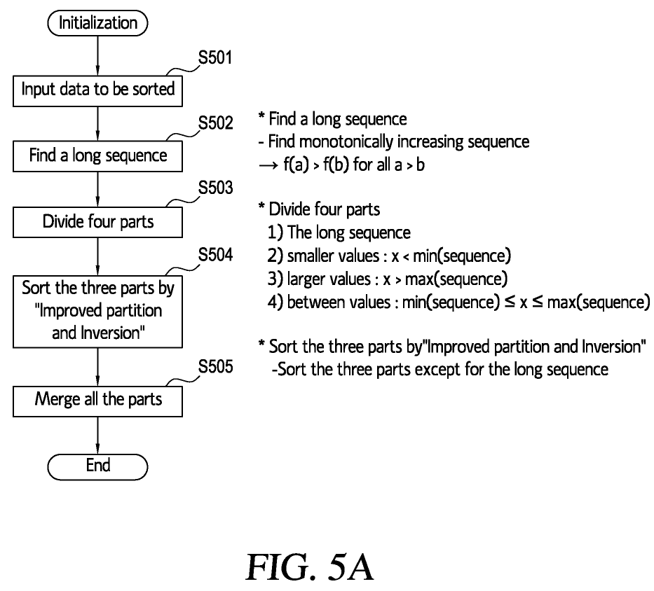

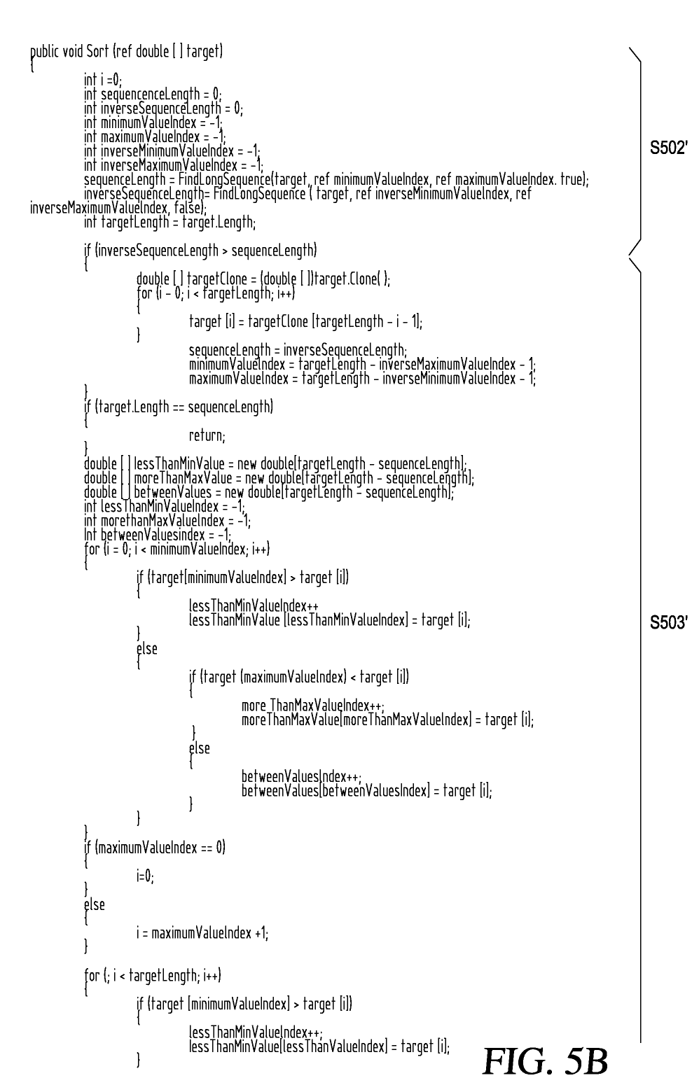

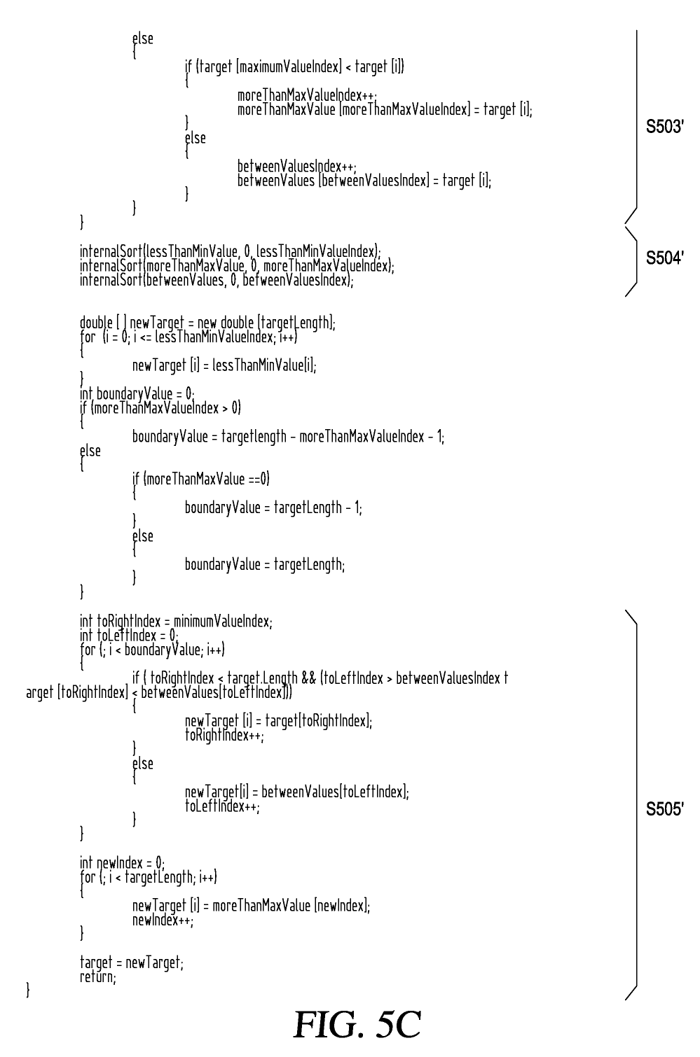

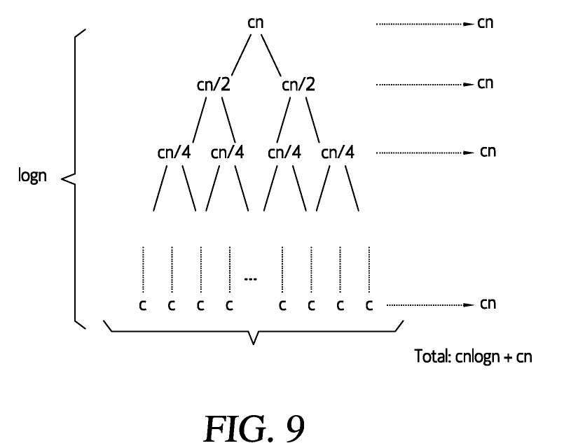

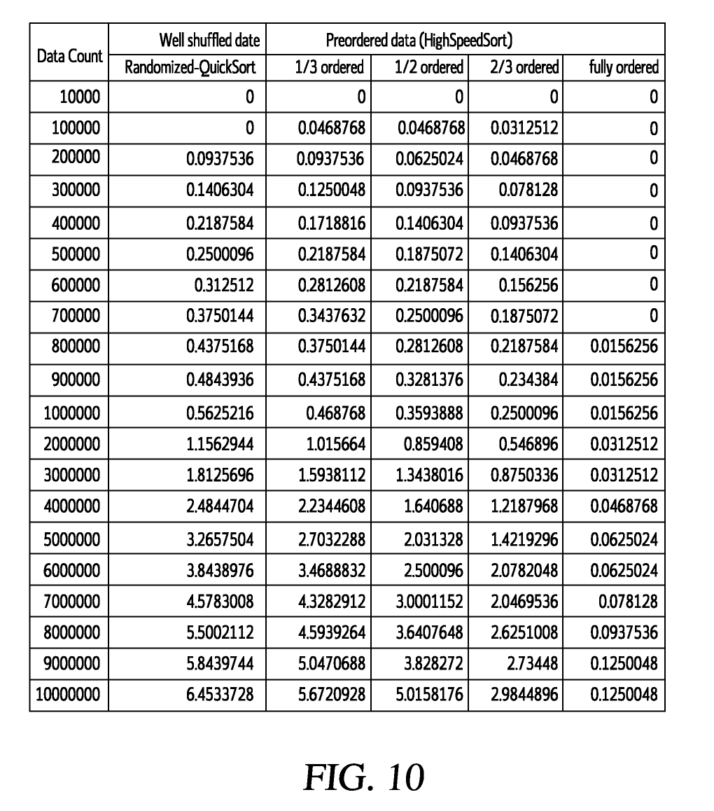

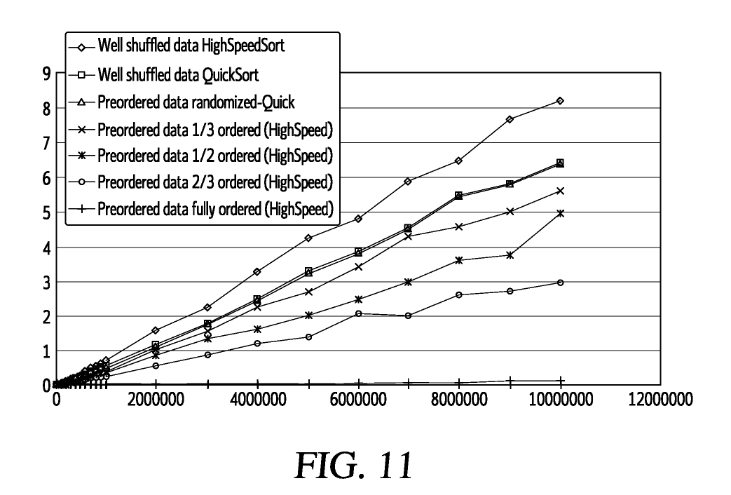

The detailed description is presented in four sections. The first section, in conjunction with FIG. 5A through 8E, comprises the Proposed Method and Algorithm of the Invention. The second section, in conjunction with FIG. 9, comprises the Qualitative Analysis of the Invention. The third section, in conjunction with FIGS. 10 and 11, comprises Illustrative Example of the Invention. The fourth section comprises Conclusions and Effect of the Invention.

### 1. THE PROPOSED METHOD AND ALGORITHM OF THE INVENTION

The purpose of the method (or algorithm) of the present invention is to improve the complexity of the sorting method (or algorithm), especially to O(n) in best case, and to O(n log n) in average or worst cases. Therefore expected average complexity coefficient can be lowered and a sorting method (or algorithm) having a better performance than Quick Sort can be achieved.

FIG. 5A is a flow chart in accordance with embodiment of the present invention.

Referring to FIG. 5A, the sorting procedure according to the invention will be explained.

Data to be sorted will be input (S501).

Then, the longest sequence which is already sorted will be searched among the whole sequence (S502). This step (S502) can be done by finding a length of a partial sequence which monotonously increases or monotonously decreases and by checking the maximum value or minimum value of the partial sequence.

Looking at the previous related work, Quick Sort has a basic weakness for the preordered data. Many improvements of Quick Sort have been developed, but they have still had asymptotic speed, O(n²). So, in this invention, finding a long sequence is proposed in order to avoid to the worst case of Quick Sort and promote the performance of sorting time.

Then, step of dividing the inputted data into four parts is performed (S503). The four parts are 1) the long sequence of step S502, 2) values which are smaller than the minimum value of the long sequence, 3) values which are larger than the maximum values of the long sequence, and 4) values which are between the minimum value of the long sequence and the maximum value of the long sequence. The sequence of 4) does not include the sequence of 1).

Then, step of sorting the three parts by “Improved partition and Inversion” is performed (S504). The three parts are the parts which are other than the long sequence. The long sequence is not included in step S504 because it is already sorted. To sort an inside of each of these three parts, step S502 to step S504 are recursively called. “Improved partition and Inversion” will be explained in detail later.

Then, step of merging all four parts is performed (S505).

FIG. 5B and FIG. 5C (continued from FIG. 5B) shows a source code list of flow chart of FIG. 5A in accordance with an embodiment of the present invention.

Specific explanations on FIGS. 5B and 5C is almost same to those on FIG. 5A.

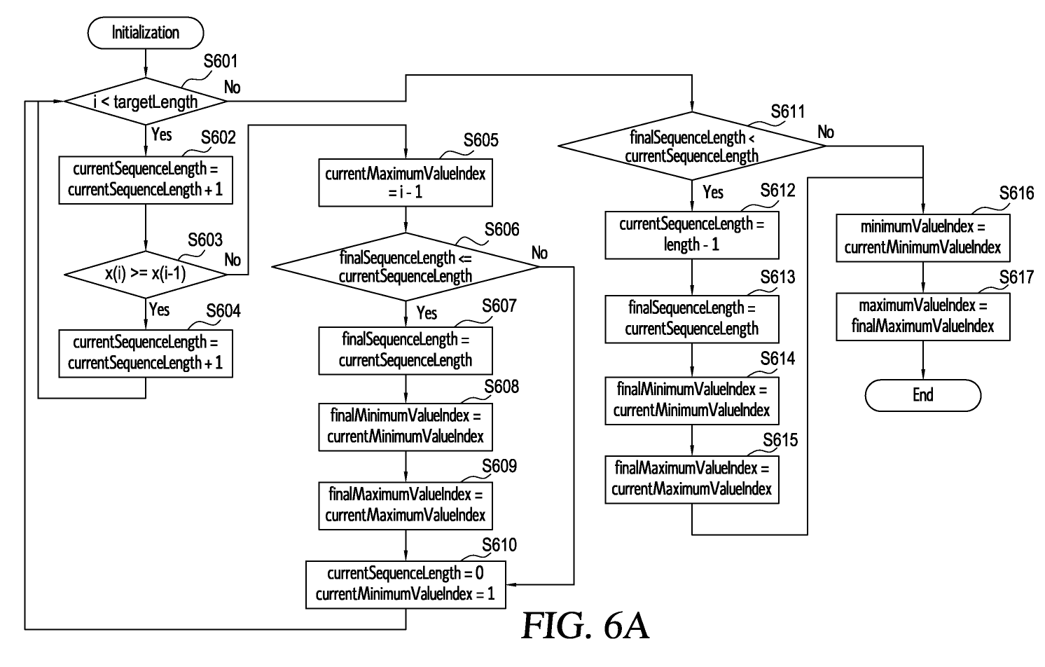

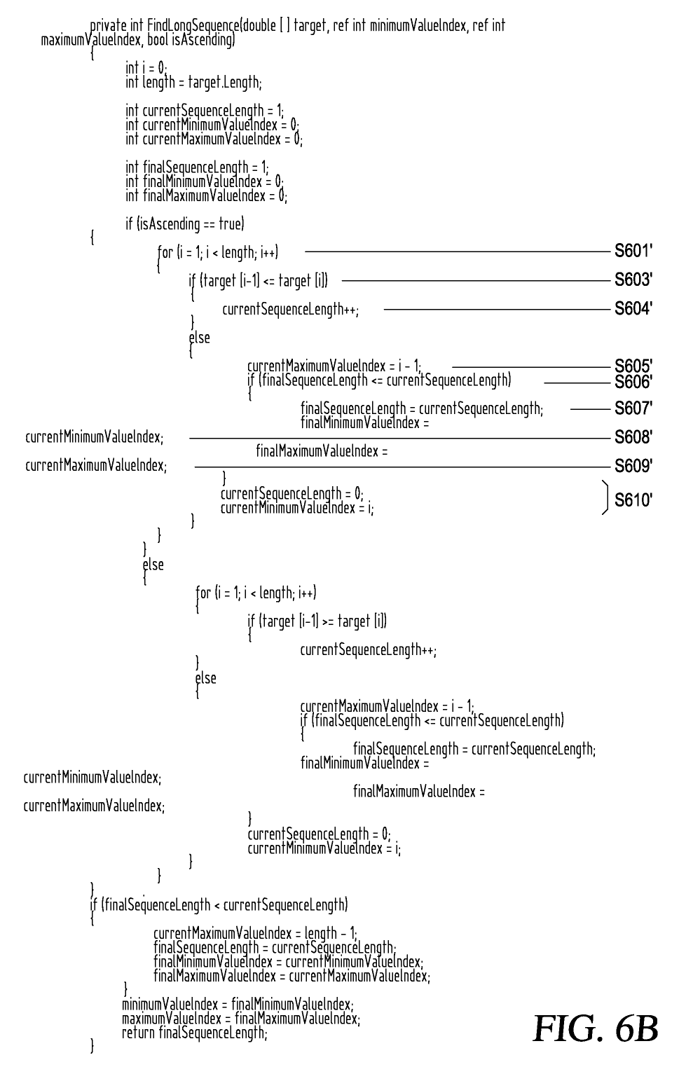

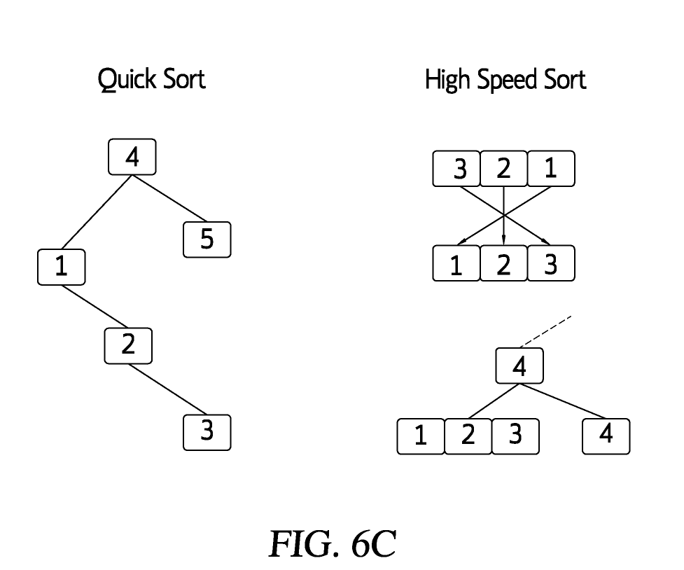

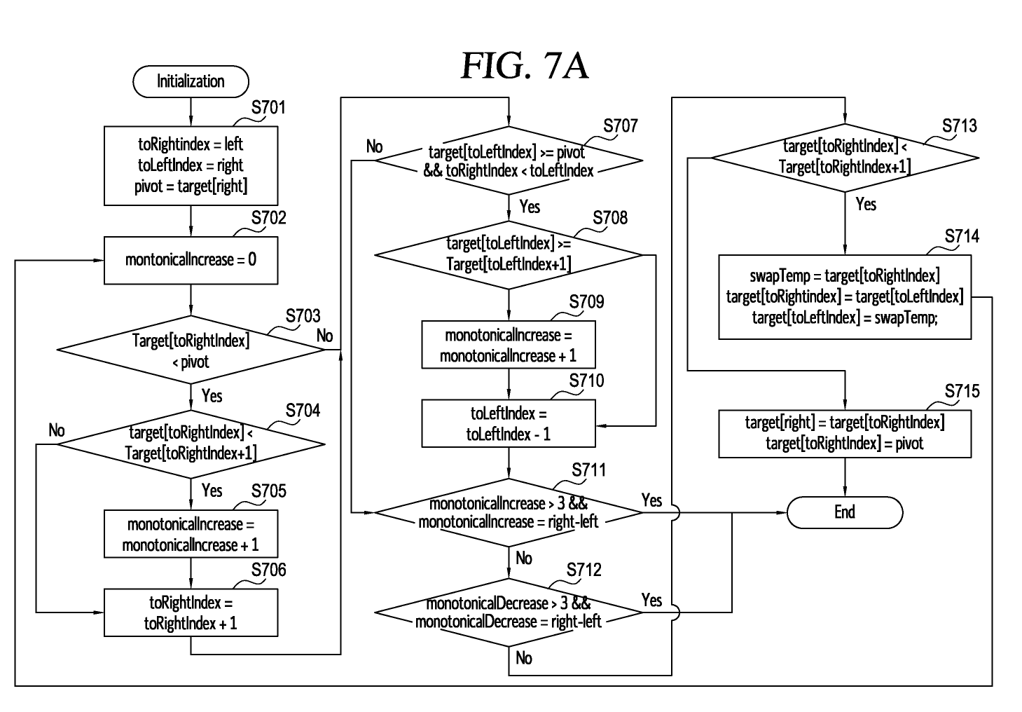

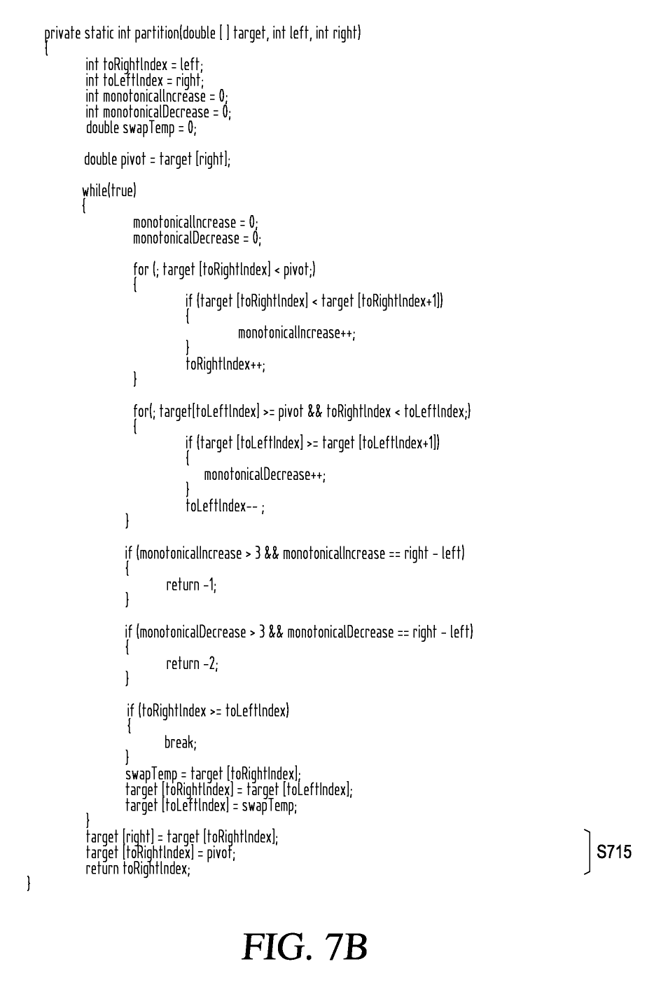

High Speed Sort of the invention is constructed by using “FindLongSequence” function (for details, see FIGS. 6A and 6B below) and “PARTITION” function (for details, see FIGS. 7A and 7B below). The specific program code is presented in FIG. 5B. as S502′.

After finding a long sequence, the three arrays are ready to be sorted. First of all, lessThanMin Values is aggregated with the values of the target array lower than the minimum value of the long sequence. Secondly, between Values is made by the values between the minimum values and the maximum values of the array. Finally, moreThanMaximumvalues is constructed by the values more than the maximum values of the array. The specific program code is presented in FIGS. 5B and 5C as S503′.

Next, internal sorting is achieved for the three subarrays, respectively. The specific program code is presented in FIG. 5C as S504′.

At the last, scanning and insertion merge about three subarrays and a long sequence will be executed. The specific program code is presented in FIG. 5C as S505′.

FIG. 6A shows an algorithm of finding a long sequence in accordance with an embodiment of the present invention.

Referring to FIG. 6A, ‘FindLongSequence’ function is to find a long sequence of the monotonous increasement in the target array and return the location of the sequential sub array there and the sequence length.

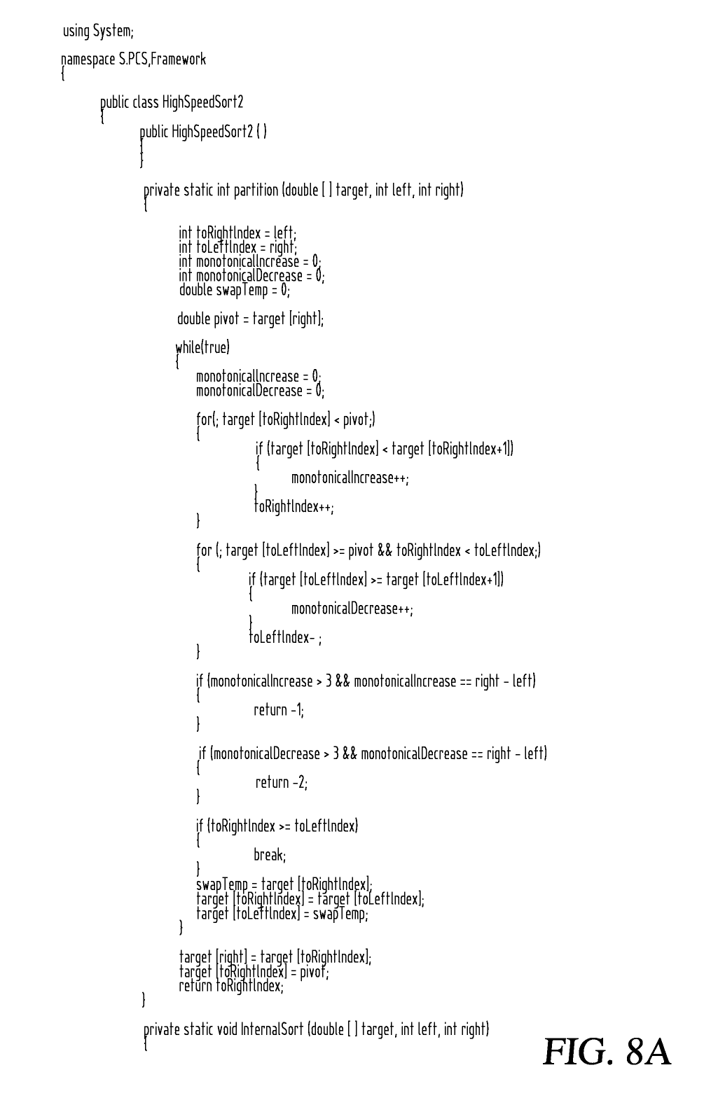

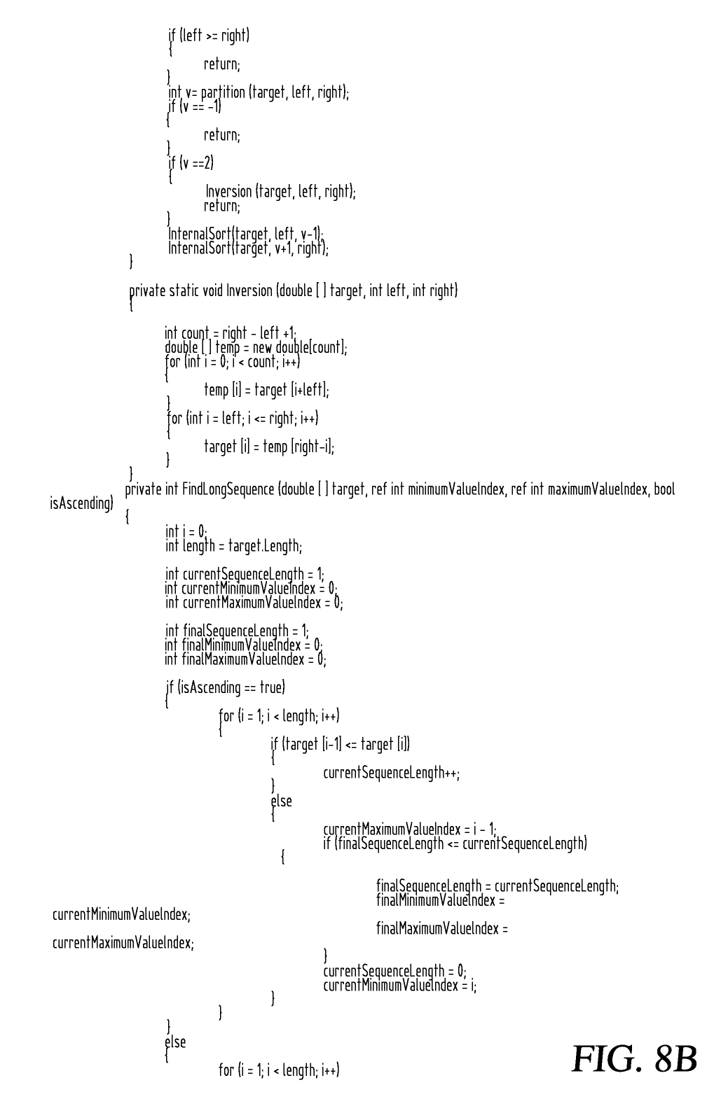

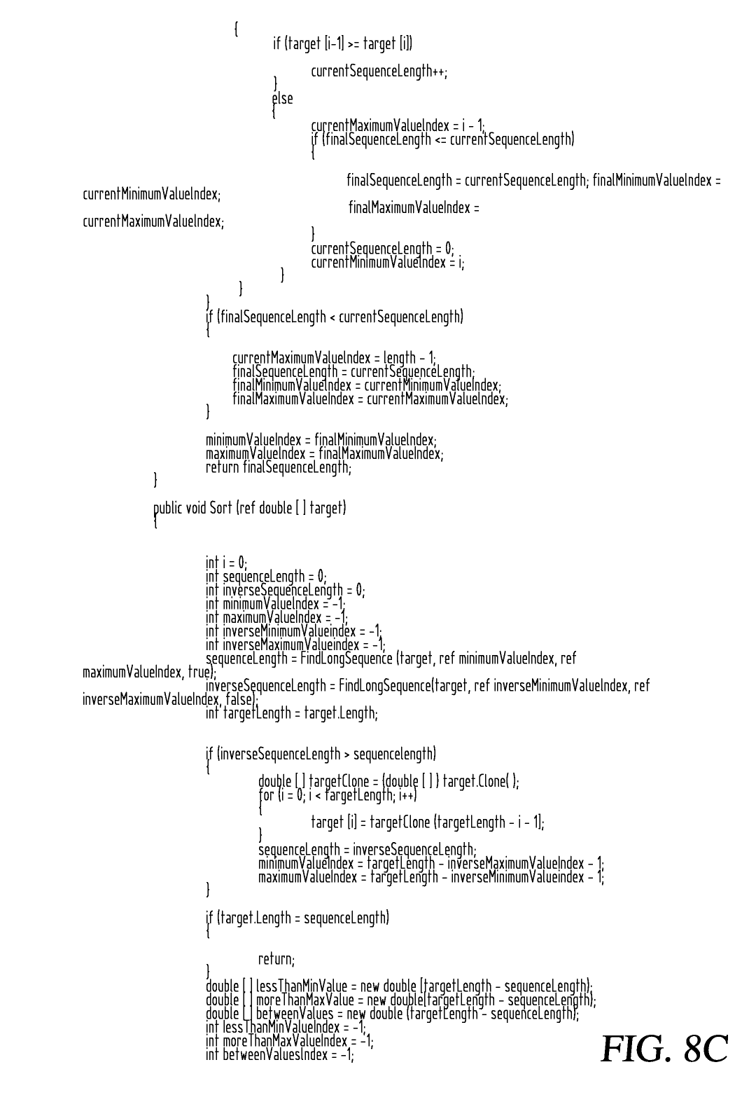

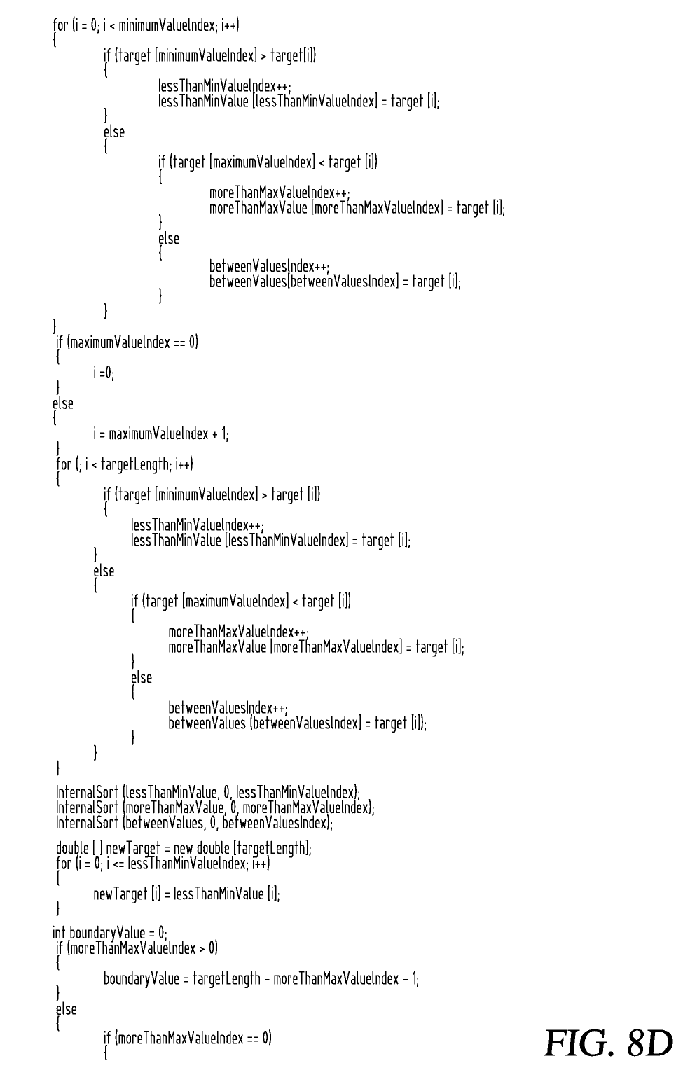

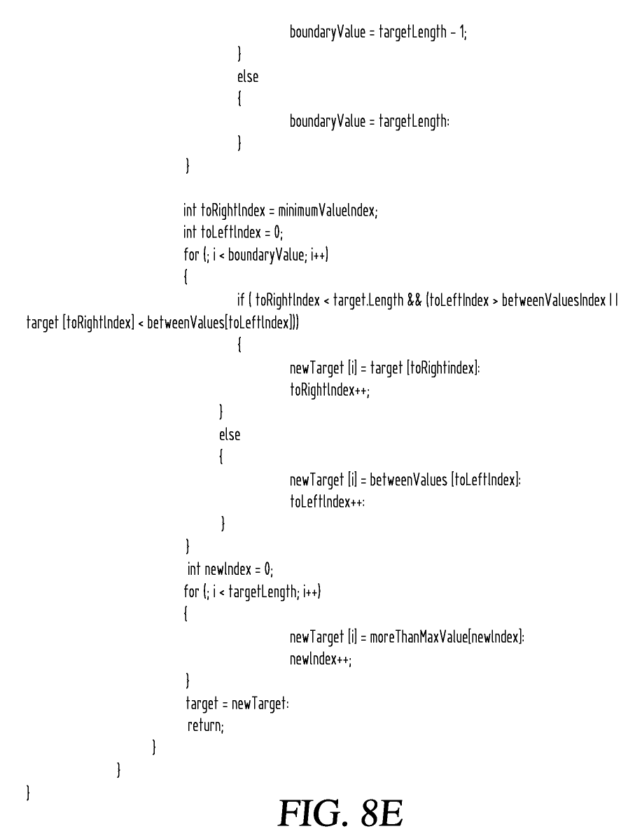

Furthermore, by checking monotonous decreasement as well as to monotonous increasement, the longest sequence among monotonously increasing sequences and monotonously decreasing sequences may be defined as “long sequence”. At this time, ‘long sequence’ is monotonously decreasing while requiring a sort of ascending order, inversion may be performed on the found sequence. A Program code of ‘Inversion’ function is illustrated as “Inversion function (private static void Inversion)” portion in FIG. 8A through 8E.

In FIG. 6A, ‘targetlength’ is a size of data to be sorted. Test is performed while increasing the value of i by 1 (S601). Step S603 checks whether there is monotonous increasement or not. If there is a monotonous increasement (Yes), the flow proceeds to step S604 and the value of ‘currentSequenceLength’ is increased by 1. The value of ‘currentSequenceLength’ is the number of monotonously increasing data which is read until now. After increasing the value of ‘currentSequenceLength’ by 1, the flow goes back to step S601 and test is performed on the value of next i.

If the answer on S603 is No (i.e., there is no monotonous increasement), the flow proceeds to step S605 and an index (i.e., ‘currentMaximumValueIndex’) of maximum value among monotonously increasing values is specified.

Next, at step S606, if ‘finalSequenceLength’≦‘currentSequenceLength’, then the flow goes back to S601 through S607, S608, S609, and S610. If ‘finalSequenceLength’>‘currentSequenceLength’, then the flow goes from S606 through S610 to S601. At this time, the variable ‘finalSequenceLength’ means the sequence length which is finally determined, the variable ‘currentSequenceLength’ means the sequence length which is determined until now.

Steps S607 to S609 are procedures for defining the ‘long sequence’ which is found until now. And, going back from S610 to S601 is procedure for seeking if there is longer sequence than the ‘long sequence’ which is found until now.

At S601, if i becomes equal to the value of ‘targetLength’ (i.e., No), the flow proceeds to S611. At this time, the longest ‘long sequence’ has already been found.

At S611, if ‘finalSequenceLength’<‘currentSequenceLength’ (i.e., Yes), then the flow goes to S616 through S612˜S615. The answer of Yes at step of S611 means that there is another value (data value) other than monotonously increasing ‘long sequence’. This means that all values have not been sorted. At this time, S612˜S615 are procedures for setting the minimum value and maximum value of the longest sequence among the found ‘long sequence.’

But, the answer of No at S611 means that all the data have been already sorted. So, the flow proceeds to S616 and S617 without undergoing S612˜S615. In this case, since data is already sorted, sorting might be finished.

It is also possible that the program recursively repeats the above-mentioned procedure until the length of ‘long sequence’ reaches to a predetermined number (e.g., 1 or 2 or 3)

FIG. 6B shows a source code list of flow chart of FIG. 6A in accordance with an embodiment of the present invention.

Referring to similar symbols as in FIG. 6A, details on FIG. 6B is same to that of FIG. 6A.

FIG. 6C shows an explanation on ‘inversion function’ which was stated above.

As shown in FIG. 6C, in case of quicksort, expansive branches occurs excessively. Thus, efficiency of sorting is reduced. However, in case of high speed sort, since sequence of ‘3, 2, 1’ is directly converted to sequence of ‘1, 2, 4’, excessive occurrence of expansive branches are prevented. One example of specific program code is shown in ‘inversion’ function of FIG. 8A through 8E which will be described later.

FIG. 7A shows an algorithm of improved partition and inversion in accordance with an embodiment of the present invention.

The novel proposed partition function shown in FIG. 7A is based on C. A. R. Hoare’ s normal partition. However, it is somewhat different from that. If the rightmost value is selected in the partition function and the subarray is preordered, moving index to right in the partition will be equal to the length of the array. When it is satisfied with this condition, the partition function is finished up.

In FIG. 7A, pointer ‘toRightIndex’ and ‘toLeftIndex’ are initiated and the rightmost element is set as pivot (comparison criteria). Variable ‘toRightIndex’ means the value which starts from the left value of the array and proceeds to the right direction. Variable ‘toLeftIndex’ means the value which starts from the right value of the array and proceeds to the left direction (S701).

Also, initiation of setting the value of ‘monotonicalIncrease’ as 0 is performed (S702).

When the conditions of steps S703 and S704 are all met, the flow goes to steps such as S705 and S706. After this procedures, ‘toRightIndex’ is moved to the right direction until it meets the value which is greater than ‘pivot’ (S706).

If condition of S703 is not met, the flow proceeds to S707.

When the conditions of S707 and S708 are all met, the flow proceeds to S709 and S710. That is, ‘toLeftIndex’ is moved to the left direction until it meets the value which is less than ‘pivot.’ (S710)

In steps S711˜S714, it is checked if there is monotonous increasement or monotonous decreasement.

If the answer on S711 is Yes, it is determined that there is as monotonous increasement and the flow is finished. If the answer on S712 is Yes, it is determined that there is monotonous decreasement and the flow is finished. If no condition on S711 and S712 is met, the flow goes to S713. For the condition on S713, if the answer if Yes, the flow proceeds to S714. Then, the flows goes back to S702. If the answer on S713 is No, the flow goes to S715 and is finished while returning ‘toRightIndex’ value.

FIG. 7B shows a source code list of flow chart of FIG. 7A in accordance with an embodiment of the present invention.

Referring to similar symbols as in FIG. 7A, details on FIG. 7B is same to that of FIG. 7A.

FIG. 8A through 8E includes illustration of FIG. 6A and FIG. 7B and is the program code representing the whole algorithm of High Speed Sort of the invention.

Specific description is as above.

Next, for example, suppose the data to be sorted is [4 7 8 9 1 3 11 10 6 5 2].

Referring to FIG. 5A through 5C, [4 7 8 9] will be found as a longest sequence(S502, S502′).

Smaller values (which are smaller than the minimum values of the long sequence) are [1 3 2]. Larger values (which are larger than the maximum values of the long sequence) are [11 10]. Between values (which are larger than or equal to the minimum values of the long sequence and are smaller than or equal to the maximum values of the long sequence) are [6 5] (S503, S503′).

Sorting smaller values results in [1 2 3]. Sorting larger values results in [9 10]. Sorting between values results in [5 6] (S504, S504′).

Then, merge all four parts (which are “long sequence”, “smaller values”, “larger values” and “between values” respectively). Advantageously, long sequence and between values are merged first by scanning and insertion method (as shown in S505′ of FIG. 5C). The result is called “long sequence+between values(merged result)”. Then, smaller values are located in front of the merged result. And, larger values are located at the back of the merged result.

In this way, sorting whose complexity is maximally O(n) might be achieved.

In FIG. 5A through 7B, only a sorting for ascending order is described. However, it is apparent to a skilled person in the art that a sorting for descending order is also possible with a little bit of modification.

### 2. QUALITATIVE ANALYSIS

2.1 Performance of Quick Sort

FIG. 9 shows the construction of a recursion tree for the recurrence.

And FIG. 9. is suggested for this equation.

Asymptotically, running time is a time function which depends on the length of the target array. The recurrence for the running time of a balanced array is then

T(n)≦2T(n/2)+Θ(n)

T(n)≦2T(n/2)+cn if c>1

c is constant to solve the problem by this algorithm.

But, for an unbalanced array,

T(n)=T(n−1)+T(0) +Θ(n)=T(n−1)+Θ(n) (1)

Let T(n) be the worst-case time for the procedure QUICK SORT on an input of size n. We have the recurrence

$$T ( n ) = {max}_{0 \leq q \leq n - 1} ( T ( q ) + T ( n - q - 1 ) ) + Θ ( n ) \qquad ( 2 )$$

where the parameter q ranges from 0 to n−1 because the procedure PARTITION produces two subprograms with total size n−1. We guess that T(n)≦cm² for some constant c. Substituting this guess into recurrence (7.1), we obtain

$$T ( n ) \leq {max}_{0 \leq q \leq n - 1} ( {cq}^{2} + {c ( n - q - 1 )}^{2} ) + Θ ( n ) = c {max}_{0 \leq q \leq n - 1} ( {q}^{2} + {( n - q - 1 )}^{2} ) + Θ ( n ) \qquad ( 3 )$$

The expression q²+(n−q−1)² achieves the maximum over the parameter's range O≦q<n−1 at either endpoint, as can be seen since the second derivative of the expression with respect to q is positive. This observation gives us the bound

$${max}_{0 \leq q \leq n - 1} ( {q}^{2} + {( n - q - 1 )}^{2} ) + Θ ( n ) \leq {( n - 1 )}^{2} = {n}^{2} - 2 n + 1 Continuing with our bounding of T ( n ) , we obtain T ( n ) \leq {cn}^{2} - c ( 2 n - 1 ) + Θ ( n ) = {cn}^{2} \qquad ( 4 )$$

If the partitioning is unbalanced, however, it can run asymptotically as slowly as the insertion sort.

According to Thomas. H. Cormen, the average case running time of Quick Sort is much closer to the best case than to the worst case as the analyses (see Thomas H. Cormen et al., “Introduction to Algorithm 2^{nd} edition”, McGraw-Hill, 2000, pp. 124˜164). Quick Sort average expected running time is O(n log n).

2.2 Performance of High Speed Sort

High Speed Sort algorithm has more components to find a long sequence, make three arrays and merge subarrays and the long sequence than those of Quick Sort. All the components have the asymptotic running time O(n) obviously.

Ironically, already ordered array which affects the weakness in Quick Sort algorithm can be very fast in the High Speed Sort. However, the expected running time is better than the best case O(n log n) of Quick Sort.

Suppose that the target array length is n, a is the size of lessThanMin Values, b is the size of between Values, c is the size of more ThanMaximum Values, and d is the size of the long sequence.

n=a+b+c+d (5)

With partition functions, lessThan MinValues, betweenValues, and moreThanMaximumValues are to be sorted in O(a log a), O(b log b), and O(c log c) respectively.

For their sorting, running time T(n) is as follows:

T(n)=k(a log a+b log b+c log c) where a+b+c=n−d.

k is a constant for asymptotic notation O.

With quadratic programming, it has the mimimal at the point, a=b=c. Also, it has the maximal point at b=0, c=0, and a=n−d.

It can be proven at the worst case T(n) which has a maximal point.

Compared to O(n log n) of the Quick Sort, High Speed Sort has a total running time equation Tₜₒₜₐₗ(n)=((n−d)log(n−d)+3n) at a constant d.

It can be written by inequality equation.

K((n−d)log(n−d)+3n)<k′(n log n) (6)

But, IMPROVED-PARTITION of the present invention is nearly similar to that of Quick Sort. Therefore, k □ k′.

(n−d)log(n−d)+3n<n log n (7)

The solution for the inequality problem will help to decide the appropriate size of the long sequence.

Moreover, it can be investigated by Expected runningtime[5]. Expected value is like this for the random variabled.

$$E ( {T}_{total} ( n ) ) = \frac{1}{n} {\sum }_{d = 0}^{d = n} ( n - d ) log ( n - d ) + 3 n \qquad ( 8 )$$

By using quadrature rule, it can be converted to an integral form.

$$\begin{matrix}{lim}_{n \to ∞} \frac{1}{n} {\sum }_{d = 0}^{d = n} ( n - d ) log ( n - d ) = {\int }_{0}^{1} nx log nx d x Substituting nx = t , & ( 9 ) \\ \frac{1}{n} {\int }_{0}^{t} t log t d t = \frac{1}{n} {\{ \frac{{t}^{2}}{2} log t ]}_{0}^{n} - {\int }_{0}^{t} d t \} \\ = \frac{n}{2} \{ log n - \frac{1}{2} \} & ( 10 )\end{matrix}$$

From above equations, although the expected running time of High Speed Sort is O(n log n), its conversion factor for the asymptotic equation is smaller than those of Quick Sort at sufficiently large no

### 3. ILLUSTRATIVE EXAMPLE

3.1 Well Shuffled Random Data

Well shuffled random data means that the monotonous sequential length is very small. In experiment, the length is the only 4˜10, which sample data sets are made from random values using the time seed in the internal clock of the computer. High Speed Sort is the slightly slower than that of Quick Sort.

3.2 Linearly Ordered Data

Linearly ordered data means that the monotonous sequential length is not small. The numbers of the length are , n/3, n/2, 2/3n, and n, which sample data sets are made from random values. Specially, fully ordered data has shown O(n).

3.3 Experiment

FIG. 10 shows comparison to Quick Sort algorithms by running time (sec) in Microsoft.NET Framework 1.1.

It can be tested by Microsoft. NET Framework 1.1 on a normal personal computer which has Pentium 4 CPU and 1 GB memory and uses Windows XP as its operating system.

Typically, this experiment for the High Speed Sort algorithm with Bubble sort and Quick Sort which are the primary algorithm in simple and recurrence algorithms,

FIG. 11 shows running time graph by the input size.

4. CONCLUSIONS

High Speed Sort algorithm is a novel idea to speed up the Quick Sort which has been considered as to be the boundary of the sorting algorithms. It can show better performance than that of Quick Sort at the appropriate conditions, sorting partially or fully ordered data.

It is noticeable that High Speed Sort achieves the performance beyond O(n log n) in the partially or fully ordered data.

Also, it needs more available memory than the other sort algorithms, because it is necessary that lessThanMinValues, moreThanMaxvalues, and between Values arrays be made.

There are many partially ordered data sets in the world. For example, semiconductor equipment data sets like PCS, which means the process control system, always are ordered, because the target value in recipe should guarantee the nearly constant sensored value. Therefore, it can be expected more improved performance.

Moreover, High Speed Sort algorithm can be implemented easily. Java or C# is the alternative programming language to help to make these algorithms (see Yoshiyuki, “Algorithm and Data structure for Java Programmer”, Softbank, 2004, pp. 310˜327)

What is claimed is:

1. A method, comprising executing an algorithm by a processor of a computer system, said executing said algorithm comprising sorting N sequences of binary bits in ascending or descending order of a value associated with each sequence, said N sequences being stored in a memory device of the computer system prior to said sorting, N being at least 2, said sorting comprising executing program code at nodes of linked execution structure, said executing program code being performed in a sequential order with respect to said nodes, said executing program code including:
a) finding a longest sequence among monotonously increasing or monotonously decreasing sequences which are from N sequences;
b) dividing said N sequences into four portions, the four portions being a long sequence, a smaller values, a larger values, and a between values, said long sequence being defined as a sequence found in step a), said smaller values being defined as a sequence of data values smaller than a minimum value among said long sequence, said larger values being defined as a sequence of data values larger than a maximum value among said long sequence, and said between values being defined as values which are larger than said minimum value among said long sequence and smaller than said maximum value among said long sequence other than said long sequence;
c) internally sorting each of said smaller values, said larger values, and said between values; and
d) merging said long sequence, said smaller values, said larger values, and between values.

2. A method according to claim 1,
said step d) includes:
d1) sorting and merging said long sequence and said between values; and
d2) merging said smaller values and said larger values into said merged sequence by step d1).

3. A method according to claim 2,
said step d1) is performed by a way of scanning and insertion merge.

4. A method according to claim 2,
in said step d2), sequence of said smaller values is merged without changing internal order, and sequence of said larger values is merged without changing internal order.

5. A method according to claim 1,
in case that said long sequence found in step a) is monotonously decreasing, further including an inversion step for changing an order of said long sequence inversely between said step a) and said step b).

6. A method according to claim 1,
in said step c),
each of said internal sorting is performed by recursively calling said step a) through said step d).

7. A method according to claim 6,
said recursive calling is repeated until length of said long sequence becomes a predetermined number.

8. A computer program product, comprising:
A computer usable medium having a computer program embodied therein, said computer readable program comprising an algorithm for Sorting N sequences of binary bits in ascending or descending order of a value associated with each sequence, said N sequences being stored in a memory device of the computer system prior to said sorting, N being at least 2, said sorting comprising executing program code at nodes of linked execution structure, said executing program code being performed in a sequential order with respect to said nodes, said executing program code including:
a) finding a longest sequence among monotonously increasing or monotonously decreasing sequences which are from N sequences;
b) dividing said N sequences into four portions, the four portions being a long sequence, a smaller values, a larger values, and a between values, said long sequence being defined as a sequence found in step a), said smaller values being defined as a sequence of data values smaller than a minimum value among said long sequence, said larger values being defined as a sequence of data values larger than a maximum value among said long sequence, and said between values being defined as values which are larger than said minimum value among said long sequence and smaller than said maximum value among said long sequence other than said long sequence;
c) internally sorting each of said smaller values, said larger values, and said between values; and
d) merging said long sequence, said smaller values, said larger values, and between values.

9. A computer program product according to claim 8, said step d) includes:
d1) sorting and merging said long sequence and said between values; and
d2) merging said smaller values and said larger values into said merged sequence by step d1).

10. A computer program product according to claim 9,
said step d1) is performed by a way of scanning and insertion merge.

11. A computer program product according to claim 9,
in said step d2), sequence of said smaller values is merged without changing internal order, and sequence of said larger values is merged without changing internal order.

12. A computer program product according to claim 8,
in case that said long sequence found in step a) is monotonously decreasing, further including an inversion step for changing an order of said long sequence inversely between said step a) and said step b).

13. A computer program product according to claim 8,
in said step c),
each of said internal sorting is performed by recursively calling said step a) through said step d).

14. A computer program product according to claim 13,
said recursive calling is repeated until length of said long sequence becomes a predetermined number.
